(19) United States
(12) Patent Application Publication
(10) Pub. No.: US 2007/0104852 A1
(43) Pub. Date: May 10, 2007

(54) Casing-packed cooked rice and its production process

(75) Inventors: Youishi Terao, Osaka (JP); Tsuyoshi Yamagata, Osaka (JP)

Correspondence Address: ROBERT J JACOBSON PA, 650 BRIMHALL STREET SOUTH, ST PAUL, MN, 551161511, US

(73) Assignee: Nitta Gelatin Inc.

(21) Appl. No.: 10/573,315

(22) PCT Filed: Jul. 7, 2004
(86) PCT No.: PCT/JP04/09985

§ 371 Date: Mar. 24, 2006

(30) Foreign Application Priority Data
Dec. 11, 2003 (JP) 2003-413715

(51) Int. Cl. A23L 1/00

(52) U.S. Cl. 426/618

(57) ABSTRACT

An object of the present invention is to provide: casing-packed cooked rice which has an excellent eating feel and an excellent flavor; and a production process which can mass-produce this casing-packed cooked rice. As a means of achieving this object, the casing-packed cooked rice according to the present invention is casing-packed cooked rice comprising an edible casing and a steam-cooked raw material for the cooked rice which material is packed in the edible casing, with the casing-packed cooked rice being characterized in that the raw material for the cooked rice contains a gelled material solidifiable when cold. The process according to the present invention for production of casing-packed cooked rice is a process comprising the steps of: packing a raw material for the cooked rice into an edible casing; and then steam-cooking the packed material; thereby obtaining the casing-packed cooked rice; with the process being characterized by further comprising the step of increasing the viscosity of the raw material for the cooked rice with a gelled material, solidifiable when cold, before the step of packing the raw material for the cooked rice.

### TECHNICAL FIELD

The present invention relates to: casing-packed cooked rice which has an excellent eating feel and an excellent flavor; and a production process which can mass-produce this casing-packed cooked rice.

### BACKGROUND ART

Hitherto, various types of casing-packed cooked rice, comprising an edible casing and the cooked rice kind (e.g. obtained by cooking raw rice (if necessary, along with such as ingredients and seasoning liquids)) packed in the edible casing, have been proposed as new processed foods convenient to carry about and possible to snack on. If they are classified roughly as to their production processes, then they can be classified into: 1) those which are obtained by a process including the steps of steam-cooking a raw material for cooked rice (e.g. raw rice, water, ingredients, seasoning liquids) to thereby cook the rice and then packing the cooked-state raw material for cooked rice into a casing; and 2) those which are obtained by a process including the steps of packing an uncooked raw material for cooked rice (e.g. raw rice, water, ingredients, seasoning liquids) into a casing and then steam-cooking the packed material to thereby cook the rice in the casing. However, as to the casing-packed cooked rice obtained by such as process 1) above (namely, the process including the step of packing the cooked-state raw material for cooked rice into the casing), there are the following problems. Grains of the cooked rice tend to be crushed when packed. Therefore, the cooked rice is pasty, bunched up together, and poor in the disintegration feeling, and therefore has a very bad eating feel. Besides, there is also proposed a process including the steps of cooking the raw material for cooked rice and then freezing the cooked material and then packing the frozen material into the casing, thus obtaining the casing-packed cooked rice. However, the product obtained by such a process is so inferior in the binding ability (feeling of unity) between the packed material and the casing as to still spoil the eating feel. Furthermore, as to the process which needs the freezing step, there are also demerits of involving the complicated production steps and therefore being inappropriate to the mass production. Accordingly, it can be considered that, of the casing-packed cooked rice having hitherto been proposed, the casing-packed cooked rice obtained by such as process 2) above (namely, the process including the steps of packing an uncooked raw material for cooked rice into the casing and then cooking the packed material in the casing) gives a better eating feel.

As the aforementioned process 2), specifically, there are proposed the following processes: a process including the steps of packing rice (having beforehand been coated with butter and/or oil-and-fat) and water into the casing and then heat-treating them (refer to patent document 1 below); a process including the steps of packing raw rice, ingredients, and a soup into the casing and then injecting air and then sealing the casing and then providing the casing with small perforations and then exposing the casing to heated steam to thereby finish up the cooked rice (refer to patent document 2 below); and a process including the steps of packing roast-treated rice and a viscous edible liquid (e.g. starch solution) (which are used as the raw material for cooked rice) into the casing and then heat-cooking them in an autoclave (refer to patent document 3 below).
[Patent Document 1] JP-A-234956/1992 (Bulletin)
[Patent Document 2] JP-A-149767/1997 (Bulletin)
[Patent Document 3] JP-A-051007/1995 (Bulletin)

However, the casing-packed cooked rice, obtained by the processes of the aforementioned patent documents 1 and 2, still tends to be pasty, bunched up together, and poor in the disintegration feeling, and therefore there is room to improve its eating feel. Particularly as to the process of the aforementioned patent document 1, there has also been a demerit of spoiling the original flavor of the rice because of beforehand coating the rice with butter and/or oil-and-fat. Furthermore, as to both processes of the aforementioned patent documents 1 and 2, there have been the following problems. Because solids (such as raw rice) and liquids (such as water and soup) must simultaneously be packed into the casing, automatic packing by a packing machine cannot be carried out. Therefore, the mass production is difficult. On the other hand, as to the process of the aforementioned patent document 3, there have been the following problems. By making the raw material for cooked rice contain the viscous edible liquid (e.g. starch solution), the automatic packing by the packing machine may become possible. However, for making this possible, the viscosity of the raw material for cooked rice needs to be made considerably high, and therefore the viscous edible liquid must be used in a large amount. The cooked rice having been finished up in such a state is very pasty, bunched up together, and poor in the disintegration feeling, so its eating feel is spoiled. In addition, also as to the process of the aforementioned patent document 3, there has also been a demerit of spoiling the original flavor of the rice because of needing to beforehand roasting the rice.

### DISCLOSURE OF THE INVENTION

Object of the Invention

Thus, an object of the present invention is to provide: casing-packed cooked rice which has an excellent eating feel and an excellent flavor; and a production process which can mass-produce this casing-packed cooked rice.

Summary of the Invention

The present inventors diligently studied to solve the above problems. As a result, the present inventors have completed the present invention by finding out that: if the raw material for cooked rice is made to contain a gelled material solidifiable when cold, then the excellent eating feel with a good disintegration feeling can be produced even though the roasting treatment or the coating treatment with such as oil-and-fat, which have a possibility of spoiling the flavor, is not carried out; and further, if the viscosity of the raw material for cooked rice is increased with the gelled material (solidifiable when cold) before the raw material for cooked rice is packed, then the mechanical packing ability is greatly enhanced, and therefore the packing by the packing machine becomes possible, so the mass production becomes possible.

That is to say, casing-packed cooked rice according to the present invention is casing-packed cooked rice comprising an edible casing and a steam-cooked raw material for the cooked rice which material is packed in the edible casing, with the casing-packed cooked rice being characterized in that the raw material for the cooked rice contains a gelled material solidifiable when cold.

A process according to the present invention for production of casing-packed cooked rice is a process comprising the steps of: packing a raw material for the cooked rice into an edible casing; and then steam-cooking the packed material; thereby obtaining the casing-packed cooked rice; with the process being characterized by further comprising the step of increasing the viscosity of the raw material for the cooked rice with a gelled material, solidifiable when cold, before the step of packing the raw material for the cooked rice.

Effects of the Invention

The present invention can easily mass-produce casing-packed cooked rice which has an excellent eating feel and an excellent flavor.

### DETAILED DESCRIPTION OF THE INVENTION

Hereinafter, detailed descriptions are given about the casing-packed cooked rice and its production process according to the present invention. However, the scope of the present invention is not bound to these descriptions. And other than the following illustrations can also be carried out in the form of appropriate modifications of the following illustrations within the scope not departing from the spirit of the present invention.

[Casing-Packed Cooked Rice]:

The casing-packed cooked rice according to the present invention is casing-packed cooked rice comprising an edible casing and a steam-cooked raw material for the cooked rice which material is packed in the edible casing. Such casing-packed cooked rice according to the present invention can easily be obtained by the below-mentioned process according to the present invention for production of casing-packed cooked rice.

The aforementioned raw material for the cooked rice includes cereals as a main component. Examples of the cereals include rice, barley, wheat, millet, corn, and pulses. However, rice is the most favorable. The cereals may be used either alone respectively or in combinations with each other. If necessary, the cereals may be those which have beforehand been washed or immersed in water.

The aforementioned raw material for the cooked rice contains water in an amount necessary for cooking the aforementioned cereals. The water may be water alone, or a water-containing seasoning material (e.g. soup) alone, or seasoning-material-containing water. Examples of the seasoning material include appropriate combinations of such as: various soups extracted from meats and vegetables; seasonings (e.g. sake, soy sauce); acidic seasonings (e.g. fruit juice, vinegar); and solid seasonings (e.g. pepper, salt, sugar, synthetic seasonings).

As to the casing-packed cooked rice according to the present invention, it is important that the aforementioned raw material for the cooked rice contains a gelled material solidifiable when cold. This can realize the excellent eating feel with a good disintegration feeling without spoiling the flavor. The aforementioned gelled material (solidifiable when cold) is free of especial limitation if it gels at normal temperature and reversibly dissolves when heated. However, examples thereof include materials produced by gelation of edible gelling agents (e.g. gelatin (powdery or grain-shaped one), agar, carrageenan, pectin, gellan gum, glucomannan, locust bean gum, xanthan gum) along with the aforementioned water. Above all, the material produced by gelation of the gelatin is particularly favorable in that a more excellent eating feel can be obtained. Hereupon, the water content of the gelled material (solidifiable when cold) may be either the entirety or a part of the water necessary for cooking the cereals. Incidentally, the gelling agents may be used either alone respectively or in combinations with each other. In addition, the form of the gelled material (solidifiable when cold) is not especially limited. It may be either particulate or mousse-form.

The content of the gelled material (solidifiable when cold) in the aforementioned raw material for the cooked rice will do if it is set appropriately for such as the kind of the gelling agent. Thus, there is no especial limitation. However, considering making a good eating feel and a good flavor express themselves and further considering the easiness of the handling with the automatic packing machine during the production, then, for example, in the case where the gelling agent is gelatin, the amount of the gelatin is favorably set so as to account for 1.0 to 10.0 weight %, more favorably 1.5 to 3.0 weight %, of the raw material for the cooked rice excluding the below-mentioned ingredients (i.e. the cereals, the water necessary for cooking the cereals, and the gelling agent). In addition, in the case where the gelling agent is a mixture of gelatin and agar, their amounts are set so as to account for the following percentages of the raw material for the cooked rice excluding the below-mentioned ingredients: favorably, the gelatin is in the range of 1.0 to 10.0 weight %, and the agar is in the range of 0.05 to 5.0 weight %; and more favorably, the gelatin is in the range of 1.5 to 3.0 weight %, and the agar is in the range of 0.2 to 1.0 weight %.

The aforementioned raw material for the cooked rice may contain ingredients appropriately in the range not spoiling the effects of the present invention. Examples of the ingredients include: livestock meats (e.g. beef, poke, chicken); processed foods (e.g. ham, sausage, tube-shaped fish paste cakes); vegetables (e.g. corn, carrot, onion); fish (e.g. cod, sea bream); and topping materials (e.g. nuts). These may be used either alone respectively or in combinations with each other. Incidentally, the ingredients may be made contained in the aforementioned gelled material (solidifiable when cold) by a method in which, when the aforementioned gelled material (solidifiable when cold) is obtained, the ingredients are mixed along with the gelling agent to thereby carry out the gelation.

The aforementioned edible casing is free of especial limitation if it is edible. However, examples thereof include: collagen casings; and natural bowels (e.g. sheep bowels). Incidentally, the aforementioned collagen casings can be obtained, for example, by a method as described in JP-A-046741/1994 (Bulletin). The shape and size of the aforementioned edible casing may be set appropriately and are therefore not especially limited.

[Process for Production of Casing-Packed Cooked Rice]:

The process according to the present invention for production of casing-packed cooked rice comprises the steps of: packing the raw material for the cooked rice into the edible casing; and then steam-cooking the packed material. As to this process, it is important that the viscosity of the aforementioned raw material for the cooked rice is increased with the gelled material (solidifiable when cold) before the aforementioned raw material for the cooked rice is packed. For the purpose of increasing the viscosity of the aforementioned raw material for the cooked rice with the gelled material (solidifiable when cold), it will do to use the raw material for the cooked rice which material contains the gelled material (solidifiable when cold) as aforementioned in the portion hereof headed “[Casing-packed cooked rice]”. If the raw material for the cooked rice is made to contain the aforementioned gelled material (solidifiable when cold), then the raw material for the cooked rice increases in viscosity to thus come into a state where the cereals (which are solid) and the water are uniformly dispersed without separation from each other. Thereby, the mechanical packing ability is greatly enhanced, and therefore the packing by the automatic packing machine becomes possible, so the casing-packed cooked rice according to the present invention can be mass-produced.

In the process according to the present invention for production of casing-packed cooked rice, it is favorable that, as the aforementioned gelled material (solidifiable when cold), there is used at least either one of: a gelled material having been formed by dissolving the edible gelling agent into water and then cooling the resultant solution; and a swollen material having been formed by making the edible gelling agent absorb water. Thereby, the raw material for the cooked rice can be dispersed more uniformly, and therefore more excellent packing ability can be obtained, so the casing-packed cooked rice having an excellent eating feel and an excellent flavor can easily be mass-produced.

Furthermore, as is aforementioned in the portion hereof headed “[Casing-packed cooked rice]”, the aforementioned gelled material (solidifiable when cold) is favorably the material produced by gelation of the gelatin. However, in the case where the gelatin is used as the edible gelling agent, there is a possibility that, if the temperature of the raw material for the cooked rice becomes high when this material is packed, then the gelatin may dissolve to unfavorably decrease the viscosity of the raw material for the cooked rice, thus resulting in the deterioration of the mechanical packing ability. In order to avoid this to maintain the good mechanical packing ability even if the temperature of the raw material for the cooked rice becomes high, in the case where the gelatin is selected as the edible gelling agent for the aforementioned gelled material (solidifiable when cold), it is effective that an edible gelling agent having a melting point higher than the gelatin is used jointly with the gelatin.

In the process according to the present invention for production of casing-packed cooked rice, it is possible to pack the aforementioned raw material for the cooked rice into the edible casing by an automatic packing machine. As to such as conditions during the packing, there is no especial limitation. They may appropriately be set. Incidentally, the edible casing, which is usable in the process according to the present invention for production of casing-packed cooked rice, is as aforementioned in the portion hereof headed “[Casing-packed cooked rice]”.

Conditions of the steam-cooking, which is carried out after having packed the raw material for the cooked rice into the edible casing; may be set appropriately for the kind of the raw material (being used) for the cooked rice (e.g. the kind of the cereals, the presence or absence of the ingredients). Thus, they are not especially limited. However, for example, heating is favorably carried out at 80 to 100° C. for 20 to 40 minutes, most favorably at 90° C. for 30 minutes. In the case where the heating temperature is lower than 80° C., it tends to be impossible to sufficiently cook the rice, or it tends to take long time to cook the rice. On the other hand, in the case where the heating temperature is higher than 100° C., there is a possibility that the casing may easily burst to thus deteriorate the productivity.

The casing-packed cooked rice according to the present invention comprises the aforementioned edible casing and the aforementioned raw material for the cooked rice which material is packed in the aforementioned edible casing in a state of the cooked rice having been produced by steam-cooking the aforementioned raw material for the cooked rice. Therefore, the cooked rice is prevented from coming apart, and its sizing and secondary processing are easy. For example, it can be processed into such as a form to be eaten in a sliced state and a form to be eaten in a skewered state. In addition, as to the casing-packed cooked rice according to the present invention, its long-time preservation can also be made by freezing or vacuum-sealing. In addition, the casing-packed cooked rice according to the present invention can be eaten in a state lightly warmed by applying thereto such as range-up or steam heating.

### DETAILED DESCRIPTION OF THE PREFERRED EMBODIMENTS

Hereinafter, the present invention is more specifically illustrated by the following Examples of some preferred embodiments in comparison with Comparative Examples not according to the present invention. However, the present invention is not limited to them. Hereinafter, unless otherwise noted, the unit “weight part(s)” is referred to simply as “part(s)”, and the unit “weight %” is referred to as “%”.

[Example 1]:

A 2.0% aqueous solution of gelatin (“Gelatin 21” produced by Nitta Gelatin Inc.: jelly strength 290 g) was heat-dissolved and then cooled to produce a gel and then particulated, thus obtaining a gelled material solidifiable when cold. Next, a raw material for cooked rice was obtained by mixing 51 parts of the above gelled material (solidifiable when cold) and 49 parts of immersed rice having been obtained by washing commercially available rice and then immersing it in water for 1 hour and then draining it of water. The resultant raw material for cooked rice was packed into an edible casing (“Nitta Collagen Casing” produced by Nitta Gelatin Inc.) by an automatic packing machine (“VF-50” produced by Handtmann Inc.). Next, the resultant packed material was steam-cooked at 90° C. in a smokehouse for 30 minutes, thus obtaining casing-packed cooked rice.

[Example 2]:

An amount of 5 parts of grain-shaped gelatin (“Noodle G” produced by Nitta Gelatin Inc.) and 95 parts of water were mixed together to thereby make the grain-shaped gelatin sufficiently absorb water, thus obtaining a swollen gelled material solidifiable when cold. Then, casing-packed cooked rice was obtained in the same way as of Example 1 except that 51 parts of the above swollen gelled material (solidifiable when cold) was substituted for the gelled material (solidifiable when cold) in Example 1.

[Example 3]:

A 2.0% aqueous solution of gelatin (“Gelatin 21” produced by Nitta Gelatin Inc.: jelly strength 290 g) was heat-dissolved and then whipped while cooled, thus obtaining a mousse-form gelled material solidifiable when cold. Then, casing-packed cooked rice was obtained in the same way as of Example 1 except that 51 parts of the above mousse-form gelled material (solidifiable when cold) was substituted for the gelled material (solidifiable when cold) in Example 1.

[Example 4]:

An amount of 1.5 parts of gelatin (“Gelatin 21” produced by Nitta Gelatin Inc.: jelly strength 290 g) and 0.2 part of agar (“S-7” produced by Ina Food Industry Co., Ltd.) were, both remaining powdery, mixed together and then heat-dissolved into 98.3 parts of water and then cooled to produce a gel and then particulated, thus obtaining a gelled material solidifiable when cold. Then, casing-packed cooked rice was obtained in the same way as of Example 1 except that 51 parts of the above gelled material (solidifiable when cold) was substituted for the gelled material (solidifiable when cold) in Example 1.

[Example 5]:

An amount of 1.5 parts of gelatin (“Gelatin 21” produced by Nitta Gelatin Inc.: jelly strength 290 g) and 0.4 part of agar (“AX-200” produced by Ina Food Industry Co., Ltd.) were, both remaining powdery, mixed together and then heat-dissolved into 98.1 parts of water and then cooled to produce a gel and then particulated, thus obtaining a gelled material solidifiable when cold. Then, casing-packed cooked rice was obtained in the same way as of Example 1 except that 51 parts of the above gelled material (solidifiable when cold) was substituted for the gelled material (solidifiable when cold) in Example 1.

[Example 6]:

An amount of 1.5 parts of gelatin (“Gelatin 21” produced by Nitta Gelatin Inc.: jelly strength 290 g) and 1.5 parts of carrageenan (“Nitta Carrageenan K-18” produced by Nitta Gelatin Inc.) were, both remaining powdery, mixed together and then heat-dissolved into 97 parts of water and then cooled to produce a gel and then particulated, thus obtaining a gelled material solidifiable when cold. Then, casing-packed cooked rice was obtained in the same way as of Example 1 except that 51 parts of the above gelled material (solidifiable when cold) was substituted for the gelled material (solidifiable when cold) in Example 1.

[Example 7]:

A 0.4% aqueous solution of agar (“AX-200” produced by Ina Food Industry Co., Ltd.) was heat-dissolved and then cooled to produce a gel and then particulated, thus obtaining a gelled material solidifiable when cold. Then, casing-packed cooked rice was obtained in the same way as of Example 1 except that 51 parts of the above gelled material (solidifiable when cold) was substituted for the gelled material (solidifiable when cold) in Example 1.

[Example 8]:

A 0.25% aqueous solution of agar (“S-7” produced by Ina Food Industry Co., Ltd.) was heat-dissolved and then cooled to produce a gel and then particulated, thus obtaining a gelled material solidifiable when cold. Then, casing-packed cooked rice was obtained in the same way as of Example 1 except that 51 parts of the above gelled material (solidifiable when cold) was substituted for the gelled material (solidifiable when cold) in Example 1.

[Example 9]:

A 1.5% aqueous solution of carrageenan (“Nitta Carrageenan K-18” produced by Nitta Gelatin Inc.) was heat-dissolved and then cooled to produce a gel and then particulated, thus obtaining a gelled material solidifiable when cold. Then, casing-packed cooked rice was obtained in the same way as of Example 1 except that 51 parts of the above gelled material (solidifiable when cold) was substituted for the gelled material (solidifiable when cold) in Example 1.

[Example 10]:

An amount of 1.5 parts of carrageenan (“Nitta Carrageenan K-18” produced by Nitta Gelatin Inc.) and 0.3 part of locust bean gum (“FT-8737” produced by Nitta Gelatin Inc.) were, both remaining powdery, mixed together and then heat-dissolved into 98.2 parts of water and then cooled to produce a gel and then particulated, thus obtaining a gelled material solidifiable when cold. Then, casing-packed cooked rice was obtained in the same way as of Example 1 except that 51 parts of the above gelled material (solidifiable when cold) was substituted for the gelled material (solidifiable when cold) in Example 1.

[Comparative Example 1]:

A 5.0% aqueous solution of starch (“MICROLYS58” produced by Oji Cornstarch Co., Ltd.) was heat-dissolved and then cooled, thus obtaining a pasty viscous liquid. Then, casing-packed cooked rice was obtained in the same way as of Example 1 except that 51 parts of the above pasty viscous liquid was substituted for the gelled material (solidifiable when cold) in Example 1.

[Comparative Example 2]:

A 2.0% aqueous solution of tamarind seed gum (“Glyloid 6C” produced by Dainippon Pharmaceutical Co., Ltd.) was heat-dissolved and then cooled, thus obtaining a pasty viscous liquid. Then, casing-packed cooked rice was obtained in the same way as of Example 1 except that 51 parts of the above pasty viscous liquid was substituted for the gelled material (solidifiable when cold) in Example 1.

The above production processes of Examples 1 to 10 and Comparative Examples 1 to 2 and the casing-packed cooked rice obtained thereby were evaluated by the following items. Then, in all these items, ⊚ was scored 3 points, ◯ was scored 2 points, Δ was scored 1 point, and X was scored 0 point, and overall evaluation was made by the total points of all the items. The results are shown in Table 1.

<Dispersibility of Raw Material for Cooked Rice>:

In the production process, the dispersed state (dispersed state of solid components) of the unpacked raw material for cooked rice was visually observed to make a judgment on the following standards:

⊚: The solid components are entirely uniformly dispersed.

◯: The solid components are almost uniformly dispersed, but a little localization is seen.

Δ: The solid components are not uniformly dispersed, but almost all of them are locally present.

X: The solid components are not dispersed at all.

<Packing Ability>:

In the production process, the workability in carrying out the packing by an automatic packing machine was judged on the following standards:

⊚: The packing can be carried out easily with no clogging in the packing machine, and further, the entire raw material for cooked rice can be packed uniformly (so that there may be no localization of the packed solid components between the beginning and end of the packing).

◯: There occurs a little localization of the packed solid components between the beginning and end of the packing, but it is possible to carry out the packing easily without clogging in the packing machine.

Δ: The clogging in the packing machine occurs so often that the packing is difficult.

X: The packing cannot be carried out at all.

<Binding Ability Between Casing and Cooked Rice in Casing-Packed Cooked Rice>:

A cut section of the resultant casing-packed cooked rice was visually observed to judge the binding ability between the casing and the cooked rice (steam-cooked raw material for the cooked rice) on the following standards:

⊚: There is no peeling (space) between the casing and the cooked rice.

◯: There is almost no peeling (space) between the casing and the cooked rice.

Δ: Peeled portions (spaces) are seen in the majority between the casing and the cooked rice.

X: The casing and the cooked rice are entirely peeled from each other.

<Disintegration Feeling of Cooked Rice in Casing-Packed Cooked Rice>:

When the resultant casing-packed cooked rice was eaten, the degree of disintegration of rice grains from each other was judged on the following standards:

⊚: The rice grains disintegrate easily from each other, so the eating feel is very good.

◯: The rice grains disintegrate from each other with a little difficulty, but the eating feel is good.

Δ: Almost no rice grains disintegrate from each other, so the eating feel is bad.

X: The rice grains are bunched up together and therefore do not disintegrate from each other at all.

<Gloss of Cooked Rice in Casing-Packed Cooked Rice>:

The cooked rice (steam-cooked raw material for the cooked rice) in the resultant casing-packed cooked rice was visually observed to judge the gloss of rice grains on the following standards:

⊚: The rice grains are white and very glossy.

◯: The rice grains are white and glossy.

Δ: The rice grains are white, but have almost no gloss.

X: The rice grains have no gloss and are yellowish.

<Hardness of Cooked Rice in Casing-Packed Cooked Rice>:

When the resultant casing-packed cooked rice was eaten, the hardness of rice grains was judged on the following standards:

⊚: The rice grains are sufficiently soft, so the eating feel is very good.

◯: The rice grains are almost soft in such a degree that the eating feel is not spoiled.

Δ: The rice grains are rather hard, so the eating feel is somewhat bad.

X: The rice grains are very hard, so the eating feel is bad.

<Flavor of Cooked Rice in Casing-Packed Cooked Rice>:

The flavor of the resultant casing-packed cooked rice was judged on the following standards:

⊚: The flavor peculiar to rice is strong, so no foreign substance smell other than the flavor peculiar to rice is felt.

◯: An extremely slight foreign substance smell other than the flavor peculiar to rice is felt, but there is the flavor peculiar to rice.

Δ: A foreign substance smell other than the flavor peculiar to rice is strong, so almost no flavor peculiar to rice is felt.

X: There is no flavor peculiar to rice, so only the foreign substance smell other than the flavor peculiar to rice is felt.

TABLE 1

| | | | Casing-packed cooked rice | | | | | |
|---|---|---|---|---|---|---|---|---|
| | | | Binding | | | | | |
| | | | ability | | | | | |
| | | | between | | | | | |
| | Dispersibility | | casing | | | | | |
| | of raw | | and | Disintegration | Gloss of | Hardness | Flavor of | |
| | material for | Packing | cooked | feeling of | cooked | of cooked | cooked | Overall |
| | cooked rice | ability | rice | cooked rice | rice | rice | rice | evaluation |
| Example 1 | ⊚ | ◯ | ⊚ | ⊚ | ⊚ | ⊚ | ⊚ | 20 |
| Example 2 | ⊚ | ⊚ | ⊚ | ⊚ | ⊚ | ⊚ | ◯ | 20 |
| Example 3 | ⊚ | ◯ | ⊚ | ⊚ | ⊚ | ⊚ | ⊚ | 20 |
| Example 4 | ⊚ | ⊚ | ⊚ | ⊚ | ⊚ | ⊚ | ⊚ | 21 |
| Example 5 | ⊚ | ⊚ | ⊚ | ⊚ | ⊚ | ⊚ | ⊚ | 21 |
| Example 6 | ⊚ | ⊚ | ⊚ | ⊚ | ⊚ | ⊚ | ⊚ | 21 |
| Example 7 | ⊚ | ⊚ | ◯ | ◯ | ◯ | ⊚ | ⊚ | 18 |
| Example 8 | ⊚ | ⊚ | ◯ | ◯ | ◯ | ◯ | ⊚ | 17 |
| Example 9 | ⊚ | ⊚ | ◯ | ◯ | ◯ | ⊚ | ⊚ | 18 |
| Example 10 | ⊚ | ⊚ | ◯ | ◯ | ◯ | ◯ | ⊚ | 17 |
| Comparative | ◯ | Δ | ◯ | X | Δ | Δ | X | 7 |
| Example 1 | | | | | | | | |
| Comparative | ◯ | Δ | Δ | X | Δ | X | Δ | 6 |
| Example 2 | | | | | | | | |

[Examples 11 to 20 and Comparative Examples 3 to 4]:

When each gelled material (solidifiable when cold) or pasty viscous liquid was prepared in the same way as of each Example shown in Table 2 among Examples 1 to 10 and Comparative Examples 1 to 2, then 0.85 part of salt, 0.1 part of pepper, 0.8 part of a beef extract (“NB-4051” produced by Nitta Gelatin Inc.), 1.2 parts of a curry powder, and 0.05 part of sodium glutamate were added as seasoning materials to water included in materials just to obtain each gelled material (solidifiable when cold) or pasty viscous liquid in a yield of 38 parts in each Example shown in Table 2. Thereby each gelled material (solidifiable when cold) or pasty viscous liquid, containing the seasoning materials, was obtained in a yield of 41 parts. Next, to this, 10 parts of sautéed minced beef and 10 parts of sautéed onion were added as ingredients to mix them together, thus obtaining a mixture. Next, each raw material for cooked rice was obtained by mixing 61 parts of the above mixture and 39 parts of immersed rice having been obtained by washing commercially available rice and then immersing it in water for 1 hour and then draining it of water. The resultant raw material for cooked rice was packed into an edible casing (“Nitta Collagen Casing” produced by Nitta Gelatin Inc.) by an automatic packing machine (“VF-50” produced by Handtmann Inc.). Next, the resultant packed material was steam-cooked at 90° C. in a smokehouse for 30 minutes, thus obtaining each casing-packed cooked rice.

The above production processes of Examples 11 to 20 and Comparative Examples 3 to 4 and the casing-packed cooked rice obtained thereby were evaluated by the following items. Then, in all these items, ⊚ was scored 3 points, ◯ was scored 2 points, Δ was scored 1 point, and X was scored 0 point, and overall evaluation was made by the total points of all the items. The results are shown in Table 2.

<Dispersibility of Raw Material for Cooked Rice>:

In the production process, the dispersed state (dispersed state of solid components) of the unpacked raw material for cooked rice was visually observed to make a judgment on the following standards:

⊚: The solid components are entirely uniformly dispersed.

◯: The solid components are almost uniformly dispersed, but a little localization is seen.

Δ: The solid components are not uniformly dispersed, but almost all of them are locally present.

X: The solid components are not dispersed at all.

<Packing Ability>:

In the production process, the workability in carrying out the packing by an automatic packing machine was judged on the following standards:

⊚: The packing can be carried out easily with no clogging in the packing machine, and further, the entire raw material for cooked rice can be packed uniformly (so that there may be no localization of the packed solid components between the beginning and end of the packing).

◯: There occurs a little localization of the packed solid components between the beginning and end of the packing, but it is possible to carry out the packing easily without clogging in the packing machine.

Δ: The clogging in the packing machine occurs so often that the packing is difficult.

X: The packing cannot be carried out at all.

<Disintegration Feeling of Cooked Rice in Casing-Packed Cooked Rice>:

When the resultant casing-packed cooked rice was eaten, the degree of disintegration of rice grains from each other was judged on the following standards:

⊚: The rice grains disintegrate easily from each other, so the eating feel is very good.

◯: The rice grains disintegrate from each other with a little difficulty, but the eating feel is good.

Δ: Almost no rice grains disintegrate from each other, so the eating feel is bad.

X: The rice grains are bunched up together and therefore do not disintegrate from each other at all.

<Hardness of Cooked Rice in Casing-Packed Cooked Rice>:

When the resultant casing-packed cooked rice was eaten, the hardness of rice grains was judged on the following standards:

⊚: The rice grains are sufficiently soft, so the eating feel is very good.

◯: The rice grains are almost soft in such a degree that the eating feel is not spoiled.

Δ: The rice grains are rather hard, so the eating feel is somewhat bad.

X: The rice grains are very hard, so the eating feel is bad.

<Dispersed State of Ingredients in Casing-Packed Cooked Rice>:

The cooked rice (steam-cooked raw material for the cooked rice) in the resultant casing-packed cooked rice was visually observed to judge the dispersed state of the ingredients on the following standards:

⊚: The ingredients are uniformly dispersed.

◯: The ingredients are almost uniformly dispersed, but a little localization is seen.

Δ: The ingredients are not uniformly dispersed, but almost all of them are locally present.

X: The ingredients are not dispersed at all.

<Color Tone of Cooked Rice in Casing-Packed Cooked Rice>:

The cooked rice (steam-cooked raw material for the cooked rice) in the resultant casing-packed cooked rice was visually observed to judge the color tone of the cooked rice on the following standards:

⊚: The cooked rice is uniformly colored.

◯: The cooked rice is almost uniformly colored with almost no unevenness of the coloring.

Δ: The coloring is much uneven.

X: The coloring is very much uneven, and some portions are not colored at all.

TABLE 2

| | Gelled | | | | | | | |
|---|---|---|---|---|---|---|---|---|
| | material | | | | | | | |
| | (solidifiable | | | Casing-packed cooked rice | | | | |
| | when cold) | Dispersibility | | | | | Color | |
| | or pasty | of raw | | Disintegration | Hardness | Dispersed | tone of | |
| | viscous | material for | Packing | feeling of | of cooked | state of | cooked | Overall |
| | liquid used | cooked rice | ability | cooked rice | rice | ingredients | rice | evaluation |
| Example 11 | Example 1 | ⊚ | ◯ | ⊚ | ⊚ | ⊚ | ⊚ | 17 |
| Example 12 | Example 2 | ⊚ | ⊚ | ⊚ | ⊚ | ⊚ | ⊚ | 18 |
| Example 13 | Example 3 | ⊚ | ◯ | ⊚ | ⊚ | ⊚ | ⊚ | 17 |
| Example 14 | Example 4 | ⊚ | ⊚ | ⊚ | ⊚ | ⊚ | ⊚ | 18 |
| Example 15 | Example 5 | ⊚ | ⊚ | ⊚ | ⊚ | ⊚ | ⊚ | 18 |
| Example 16 | Example 6 | ⊚ | ⊚ | ⊚ | ⊚ | ⊚ | ⊚ | 18 |
| Example 17 | Example 7 | ⊚ | ⊚ | ◯ | ⊚ | ⊚ | ⊚ | 17 |
| Example 18 | Example 8 | ⊚ | ⊚ | ◯ | ◯ | ⊚ | ◯ | 15 |
| Example 19 | Example 9 | ⊚ | ⊚ | ◯ | ⊚ | ⊚ | ⊚ | 17 |
| Example 20 | Example 10 | ⊚ | ⊚ | ◯ | ◯ | ⊚ | ⊚ | 16 |
| Comparative | Comparative | ◯ | X | X | Δ | Δ | Δ | 5 |
| Example 3 | Example 1 | | | | | | | |
| Comparative | Comparative | ◯ | X | X | X | Δ | Δ | 4 |
| Example 4 | Example 2 | | | | | | | |

### INDUSTRIAL APPLICATION

The casing-packed cooked rice according to the present invention can be mass-produced and provided to consumers as a new processed food convenient to carry about and possible to snack on. For example, this casing-packed cooked rice can easily adopt the form of being sold at such as convenience stores, tourist resorts, stands, and stalls.

1. Casing-packed cooked rice, which is casing-packed cooked rice comprising an edible casing and a steam-cooked raw material for the cooked rice which material is packed in the edible casing, with the casing-packed cooked rice being characterized in that the raw material for the cooked rice contains a gelled material solidifiable when cold.

2. A process for production of casing-packed cooked rice, which is a process comprising the steps of: packing a raw material for the cooked rice into an edible casing; and then steam-cooking the packed material; thereby obtaining the casing-packed cooked rice;
with the process being characterized by further comprising the step of increasing the viscosity of the raw material for the cooked rice with a gelled material, solidifiable when cold, before the step of packing the raw material for the cooked rice.

3. A process according to claim 2 for production of casing-packed cooked rice, wherein, as the gelled material solidifiable when cold, there is used at least either one of: a gelled material having been formed by dissolving an edible gelling agent into water and then cooling the resultant solution; and a swollen material having been formed by making the edible gelling agent absorb water.
